(19) United States
(12) Patent Application Publication
(10) Pub. No.: US 2026/0341875 A1
(43) Pub. Date: Oct. 29, 2026

(54) SOLID-STATE CENTRALIZED HYDRAULIC MODULE

(71) Applicant: Schaeffler Technologies AG & Co. KG, Herzogenaurach (DE)

(72) Inventors: Paul Lindemann, Howard, OH (US); Joshua Hixenbaugh, Wooster, OH (US)

(21) Appl. No.: 19/652,666

(22) Filed: Apr. 20, 2026

Related U.S. Application Data
(60) Provisional application No. 63/793,608, filed on Apr. 23, 2025.

(51) Int. Cl. H01M 50/242; H01M 10/42; H01M 50/244

(52) U.S. Cl. CPC H01M 50/242; H01M 10/425; H01M 50/244; H01M 2010/4271

(57) ABSTRACT

A solid-state battery module may include one or more battery stacks, each of the one or more battery stacks comprising a plurality of battery cells stacked upon each other. The solid-state battery module may include one or more hydraulic piston systems. Each of the one or more hydraulic piston systems may include one or more pistons configured to apply a pressure to the one or more battery stacks based on charge state of the one or more battery stacks. Each of the pistons may include a body and a head at an end of the body, wherein the head is in contact with the one or more battery stacks. Each of the one or more hydraulic piston systems may include a housing surrounding the one or more pistons, wherein the one or more pistons extend from the housing to apply the pressure on the one or more battery stacks.

### CROSS-REFERENCE TO RELATED APPLICATION

The present application claims the benefit under 35 U.S.C. § 119(e) of U.S. Provisional Application Serial Number 63/793,608, filed Apr. 23, 2025, entitled SOLID STATE CENTRALIZED HYDRAULIC MODULE, which is incorporated herein by reference in its entirety.

### TECHNICAL FIELD

The present disclosure generally relates to solid-state batteries, and, more particularly, to compression of solid-state batteries.

### BACKGROUND

All-solid-state battery (ASSB) cells require a sustained stack pressure during charge and discharge cycling to maintain interfacial contact between internal layers and prevent degradation mechanisms such as dendrite formation. This pressure must be maintained even as the cells undergo significant volumetric changes which can result in up to 20% thickness variation between charged and discharged states. Without adequate and uniform compression, ASSB performance deteriorates rapidly, leading to reduced cycle life and potential safety risks.

In electric vehicle (EV) applications, where compact packaging and high energy density are critical, the challenge of maintaining consistent stack pressure is compounded by space constraints and the need for modular, scalable battery architectures. Existing solutions, such as mechanical springs or compliant materials, provide only passive pressure control and cannot maintain a constant force across the full range of cell expansion. Similarly, gas-based systems (e.g., nitrogen struts) exhibit variable pressure characteristics that are difficult to tune precisely and may not meet the stringent requirements of certain cell chemistries or operating conditions.

### SUMMARY

A solid-state battery module is disclosed, in accordance with one or more embodiments of the present disclosure. In embodiments, the solid-state battery module includes one or more battery stacks, each of the one or more battery stacks comprising a plurality of battery cells stacked upon each other. In embodiments, the solid-state battery module includes one or more hydraulic piston systems. In embodiments, each of the one or more hydraulic piston systems includes one or more pistons configured to apply a pressure to the one or more battery stacks based on charge state of the one or more battery stacks. In embodiments, each of the one or more pistons includes a body and a head at an end of the body, wherein the head is in contact with the one or more battery stacks. In embodiments, each of the one or more hydraulic piston systems includes a housing surrounding the one or more pistons, wherein the one or more pistons extend from the housing to apply the pressure on the one or more battery stacks.

In some aspects, the one or more battery stacks further include a first battery stack and a second battery stack.

In some aspects, the one or more hydraulic piston systems are disposed between the first battery stack and the second battery stack.

In some aspects, the one or more pistons further include a first piston and a second piston, wherein the housing surrounds both the first piston and the second piston, wherein the first piston and the second piston extend from opposite sides of the housing such that the first piston applies the pressure to the first battery stack and the second piston applies the pressure to the second battery stack.

In some aspects, when the first piston and the second piston are unextended, the second piston is designed to nest inside the first piston.

In some aspects, the one or more battery stacks include a single battery stack.

In some aspects, the one or more pistons include a single piston to apply pressure to the single battery stack.

In some aspects, each of the one or more pistons further includes a lip at an opposite end of the body from the head.

In some aspects, the housing further includes one or more restriction lips corresponding to the one or more pistons, wherein the one or more restriction lips are designed to restrict motion of the one or more pistons by physical interaction with the lip of each of the one or more pistons.

In some aspects, each of the one or more battery stacks further includes an end plate.

In some aspects, the end plate of each of the one or more battery stacks is designed to absorb the pressure applied by the one or more pistons.

In some aspects, the end plate of each of the one or more battery stacks is designed to provide a mounting point for the one or more battery stacks.

In some aspects, a material is disposed between each of the plurality of battery cells of the one or more battery stacks.

In some aspects, the material disposed between each of the plurality of battery cells of the one or more battery stacks is at least one of a compliant material, a heating mat, or a cooling loop.

In some aspects, the pressure applied to the one or more battery stacks based on the charge state of the one or more battery stacks is designed to be a constant pressure based on expansion and contraction of the plurality of battery cells of the one or more battery stacks.

In some aspects, the head of each of the one or more pistons is designed such that the one or more pistons apply the pressure to an entire surface of the one or more battery stacks.

In some aspects, the solid-state battery module further includes a controller communicatively coupled to the one or more hydraulic piston systems, the controller including one or more processors programmed to execute a set of program instructions stored in memory, which when executed, causes the one or more processors to cause the one or more pistons to actuate to apply the pressure to the one or more battery stacks.

In some aspects, the controller is further configured to monitor the charge state of the one or more battery stacks and cause the one or more pistons to apply different pressures to the one or more battery stacks as the charge state of the one or more battery stacks changes.

An electric vehicle is disclosed, in accordance with one or more embodiments of the present disclosure. In embodiments, the electric vehicle includes an electric drive train. In embodiments, the electric vehicle includes a solid-state battery module to power the electric drivetrain. In embodiments, the solid-state battery module includes one or more battery stacks, each of the one or more battery stacks comprising a plurality of battery cells stacked upon each other. In embodiments, the solid-state battery module includes one or more hydraulic piston systems. In embodiments, each of the one or more hydraulic piston systems includes one or more pistons configured to apply a pressure to the one or more battery stacks based on charge state of the one or more battery stacks. In embodiments, each of the one or more pistons includes a body and a head at an end of the body, wherein the head is in contact with the one or more battery stacks. In embodiments, each of the one or more hydraulic piston systems includes a housing surrounding the one or more pistons, wherein the one or more pistons extend from the housing to apply the pressure on the one or more battery stacks.

A method is disclosed, in accordance with one or more embodiments of the present disclosure. In embodiments, the method includes a step of providing one or more battery stacks, each of the one or more battery stacks comprising a plurality of battery cells stacked upon each other. In embodiments, the method includes a step of positioning one or more hydraulic piston systems adjacent to the one or more battery stacks. In embodiments, each of the one or more hydraulic piston systems includes one or more pistons configured to apply a pressure to the one or more battery stacks based on charge state of the one or more battery stacks. In embodiments, each of the one or more pistons includes a body and a head at an end of the body, wherein the head is in contact with the one or more battery stacks. In embodiments, each of the one or more hydraulic piston systems includes a housing surrounding the one or more pistons, wherein the one or more pistons extend from the housing to apply the pressure on the one or more battery stacks. In embodiments, the method includes a step of applying a pressure to the one or more battery stacks with the one or more pistons based on charge state of the one or more battery stacks.

### BRIEF DESCRIPTION OF THE DRAWINGS

The numerous advantages of the disclosure may be better understood by those skilled in the art by reference to the accompanying figures.

FIG. 1A depicts a cross-sectional view of an unextended hydraulic piston system, in accordance with one or more embodiments of the present disclosure.

FIG. 1B depicts a cross-sectional view of an extended hydraulic piston system, in accordance with one or more embodiments of the present disclosure.

FIG. 2A depicts a cross-sectional view of a solid-state battery module with an unextended hydraulic piston system, in accordance with one or more embodiments of the present disclosure.

FIG. 2B depicts a cross-sectional view of the solid-state battery module with an extended hydraulic piston system, in accordance with one or more embodiments of the present disclosure.

FIG. 3A depicts a cross-sectional view of a solid-state battery module with an unextended hydraulic piston system, in accordance with one or more embodiments of the present disclosure.

FIG. 3B depicts a cross-sectional view of the solid-state battery module with an extended hydraulic piston system, in accordance with one or more embodiments of the present disclosure.

FIG. 4 depicts a perspective view of the solid-state battery module, in accordance with one or more embodiments of the present disclosure.

FIG. 5A depicts a cross-sectional view of a solid-state battery module with an unextended hydraulic piston system including a single piston, in accordance with one or more embodiments of the present disclosure.

FIG. 5B depicts a cross-sectional view of the solid-state battery module with an extended hydraulic piston system including the single piston, in accordance with one or more embodiments of the present disclosure.

FIG. 6 depicts a block diagram of the hydraulic piston system, in accordance with one or more embodiments of the present disclosure.

FIG. 7 depicts a block diagram of an electric vehicle including the solid-state battery module incorporating the hydraulic piston system, in accordance with one or more embodiments of the present disclosure.

FIG. 8 depicts a flow diagram of a method for compression of battery stacks in solid-state battery modules, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure are directed to a hydraulic piston system. The solid-state battery module may incorporate a compact, actively controlled hydraulic piston system designed to apply and maintain uniform stack pressure across one or more battery stacks. The hydraulic piston system may include one or more pistons housed within a central hydraulic assembly, where each piston may extend to apply a controlled compressive force to a battery stack. The pistons may be nested to reduce overall module length and accommodate significant cell expansion during charge and discharge cycles.

The hydraulic piston system may maintain a substantially constant pressure across the battery stack, or may vary the applied pressure in response to high-current events such as fast charging or peak discharge. The disclosed architecture may enable a scalable, modular, and space-efficient solution for pressure management in solid-state battery modules, supporting improved performance, safety, and longevity in electric vehicle and other high-demand energy storage applications.

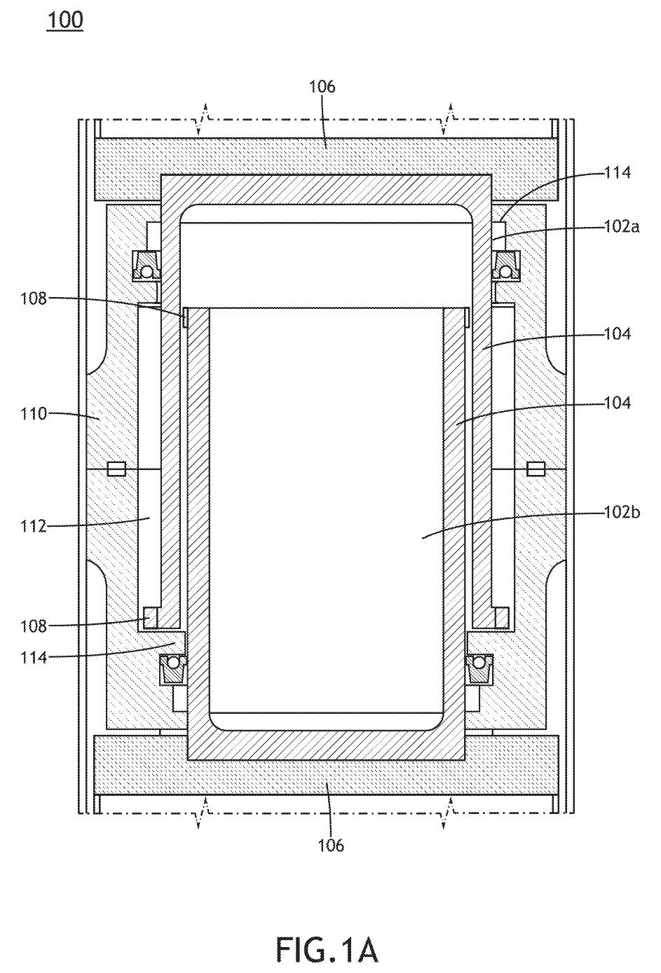

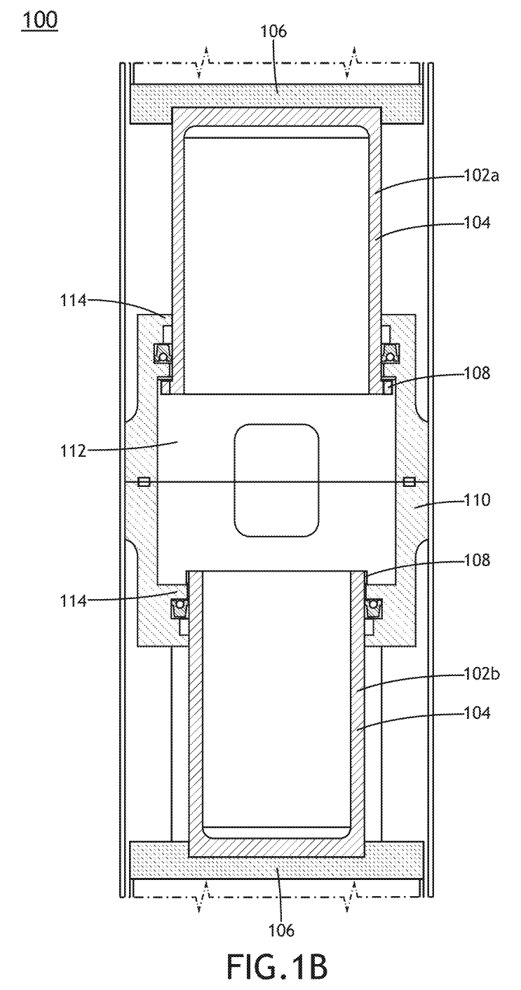

FIG. 1A depicts a cross-sectional view of an unextended hydraulic piston system 100, in accordance with one or more embodiments of the present disclosure.

The hydraulic piston system 100 may be configured to apply a compressive force to one or more solid-state battery stacks to maintain a desired stack pressure during operation. The hydraulic piston system 100 may be particularly suited for use in battery modules incorporating all-solid-state battery (ASSB) cells, which require consistent stack pressure to maintain interfacial contact between internal layers and to mitigate degradation mechanisms such as dendrite formation.

In embodiments, the hydraulic piston system 100 includes one or more pistons 102. The pistons 102 may be configured to extend and retract to apply pressure to adjacent battery stacks. The hydraulic piston system 100 may include any number of pistons. For example, the number of pistons 102 may vary depending on the configuration of the battery module, and may include single-ended or dual-ended arrangements.

In embodiments, each of the one or more pistons 102 includes a body 104. The body 104 may take any shape and be made from any material suitable for applying compressive forces. For example, the body 104 may be cylindrical, tubular, or polygonal in cross-section, and may be formed from a rigid material such as aluminum, stainless steel, or carbon fiber-reinforced composites. The body 104 may be dimensioned to allow for telescoping or nesting of multiple pistons, thereby enabling a long stroke length while minimizing the overall length of the hydraulic piston system 100. Surface treatments such as anodizing or low-friction coatings may be applied to reduce wear and improve sealing performance.

In embodiments, each of the one or more pistons 102 includes a head 106. The head 106 may be configured to interact with (e.g., apply pressure on) an outside body, such as components in a solid-state battery.

In embodiments, each of the one or more pistons 102 includes a lip 108. The lip 108 may serve as a mechanical stop or retention feature. In this way, the lip 108 may prevent overextension of the piston 102 and ensure controlled displacement during actuation.

In embodiments, the hydraulic piston system 100 includes a housing 110 surrounding the pistons 102. The housing 110 may be configured to contain and guide the motion of the pistons 102, and may also serve as a fluid chamber for hydraulic actuation. The housing 110 may be formed from a rigid material capable of withstanding internal hydraulic pressures and external mechanical loads. Additionally, the housing 110 may be modular and designed for ease of assembly and maintenance.

The housing 110 may include an opening 112 to receive the pistons 102 (e.g., the body 104 of the pistons 102). The opening 112 may be dimensioned to allow for smooth sliding of the pistons while maintaining a fluid-tight seal. For example, sealing elements such as O-rings, gaskets, or bellows may be incorporated to prevent fluid leakage and to isolate the hydraulic fluid from the operating environment.

In embodiments, the housing 110 includes one or more restriction lips 114. The restriction lips 114 may be positioned within the housing 110 to physically engage the lip 108 of the pistons 102, thereby limiting the range of motion and preventing overextension of the pistons 102. The restriction lips 114 may also serve to maintain alignment and stability of the pistons 102 during actuation.

FIG. 1B depicts a cross-sectional view of an extended hydraulic piston system 100, in accordance with one or more embodiments of the present disclosure. In the extended configuration, the pistons 102 may be displaced outward from the housing 110, applying a compressive force from the hydraulic piston system 100. The extension may be driven by hydraulic fluid pressure within the housing 110, controlled by a hydraulic subsystem as described below.

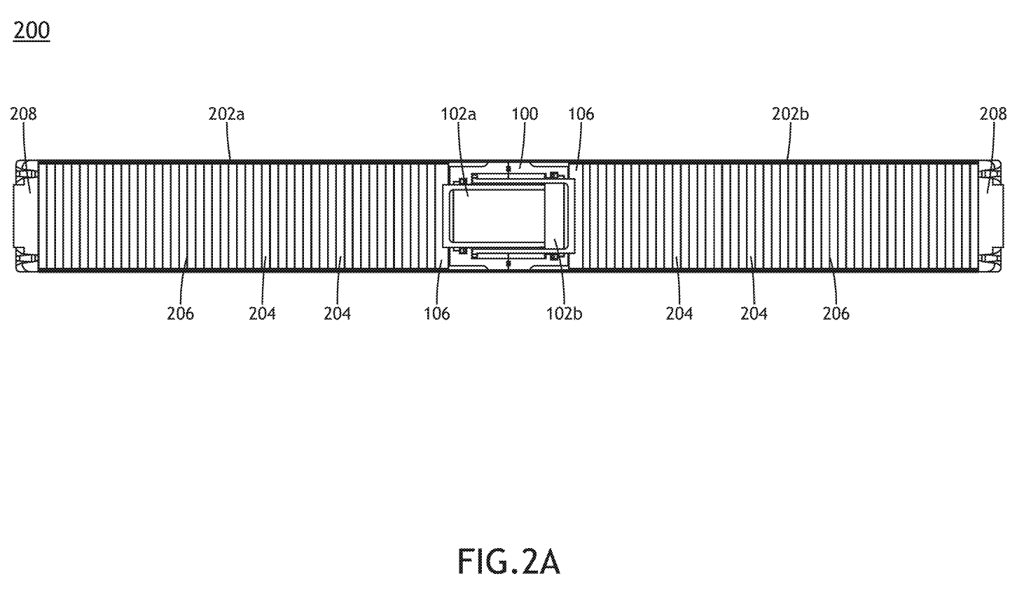

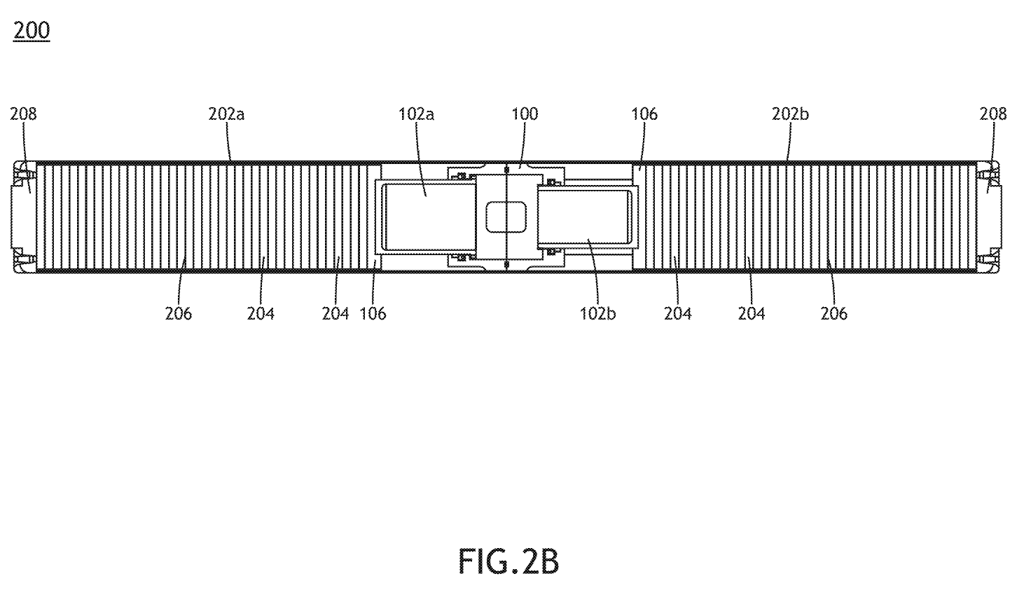

FIG. 2A depicts a cross-sectional view of a solid-state battery module 200 with an unextended hydraulic piston system 100, in accordance with one or more embodiments of the present disclosure. FIG. 2B depicts a cross-sectional view of the solid-state battery module 200 with an extended hydraulic piston system 100, in accordance with one or more embodiments of the present disclosure.

In embodiments, the solid-state battery module 200 includes one or more battery stacks 202. Each battery stack 202 may be configured to store electrical energy.

The head 106 may be configured to interface with a battery stack 202, such as by directly contacting the battery stack 202. The head 106 may be shaped in any way to distribute pressure uniformly across the surface of the battery stack 202. For example, the head 106 may include a flat, contoured, or compliant surface to accommodate minor variations in stack geometry. By way of another example, the head 106 (or multiple heads 106 corresponding to multiple pistons 102) may be designed to apply pressure across the entire surface of the battery stack 202 to ensure uniform compression.

The hydraulic piston system 100 may be configured to apply a selected pressure. For example, the hydraulic piston system 100 may be configured to apply a pressure in the range of approximately zero to five megapascals (MPa) to the battery stack. It is noted that other pressure ranges may be used depending on the requirements of the battery chemistry and application. The hydraulic piston system 100 may maintain a substantially constant pressure across the battery stacks 202 during both charging and discharging cycles, compensating for expansion and contraction. Additionally, the pressure may be dynamically adjusted based on the charge state, temperature, or current load of the battery.

Each battery stack 202 may be formed from battery cells 204 stacked upon each other. The battery cells 204 may take on a variety of forms. For example, the battery cells 204 may be pouch-type, prismatic, or other form factors suitable for solid-state chemistries. The battery cells 204 may be arranged in a vertical or horizontal orientation depending on the packaging constraints of the application.

In embodiments, material 206 is disposed between each (or some) of the battery cells 204 forming the battery stacks 202. The material 206 may include any materials appropriate for use with battery stacks 202. For example, the material 206 may include compliant materials to enhance pressure uniformity, heating mats to maintain optimal cell temperature, or cooling loops to dissipate heat during high-power operation. The inclusion of such material 206 may be tailored to the thermal and mechanical requirements of the specific battery cells 204 being used in the solid-state battery module 200.

In embodiments, each of the battery stacks includes an end plate 208. The end plate 208 may be formed from a rigid material and may serve to distribute and/or absorb the compressive force applied by the pistons 102 across the battery stack 202. The end plate 208 may also include mounting features (or act as a mounting point) for integration of the solid-state battery module 200 into a larger battery pack or vehicle chassis.

In embodiments, one or more battery stacks 202 include two or more battery stacks 202. For example, the one or more battery stacks 202 may include, but are not limited to, a first battery stack 202a and a second battery stack 202b. This configuration may allow for a centrally located hydraulic piston system 100 to apply pressure to both battery stacks 202 simultaneously.

When the one or more battery stacks 202 include the first battery stack 202a and the second battery stack 202b, the hydraulic piston system 100 may be disposed between the first battery stack 202aand the second battery stack 202b. This arrangement may reduce the overall length of the solid-state battery module 200 and may enable a more compact packaging architecture.

In embodiments, the one or more pistons 102 include two or more pistons. For example, the one or more pistons 102 may include a first piston 102aand a second piston 102b. The first piston 102aand second piston 102bmay extend from opposite sides of the housing 110, such that the first piston 102a applies pressure to the first battery stack 202a and the second piston 102b applies pressure to the second battery stack 202b.

In the unextended configuration, the second piston 102b may be designed to nest within the first piston 102a(e.g., the body 104 of the second piston 102brests inside the body 104 of the first piston 102a). This nested configuration may allow for a reduced stack height and may facilitate integration into space-constrained environments such as electric vehicle battery compartments.

The transition between the unextended and extended state of the hydraulic piston system 100 may correspond to changes in the height of the battery stack 202 due to the breathing effect of the battery cells 204 forming the battery stack 202. For example, the hydraulic piston system 100 may be designed to accommodate up to approximately 20% expansion in height of the battery stacks 202, without loss of pressure uniformity.

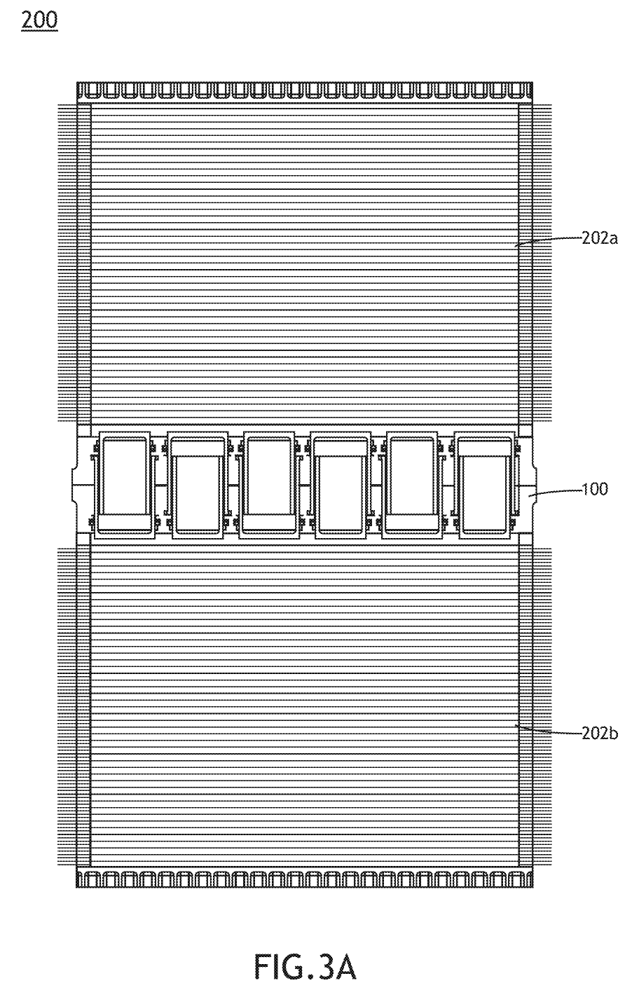

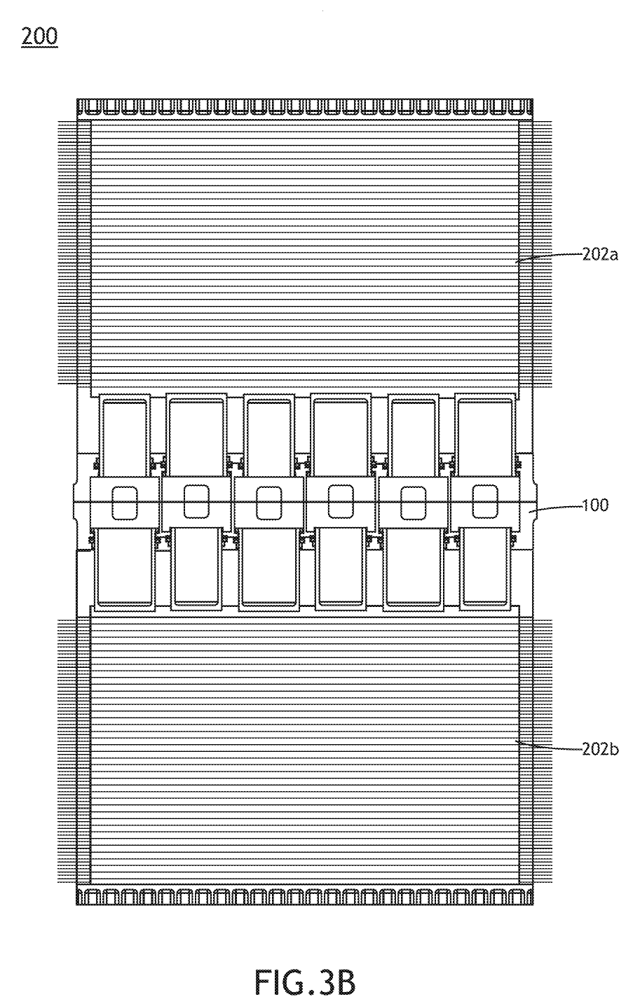

FIG. 3A depicts a cross-sectional view of a solid-state battery module 200 with an unextended hydraulic piston system 100, in accordance with one or more embodiments of the present disclosure. FIG. 3B depicts a cross-sectional view of the solid-state battery module 200 with an extended hydraulic piston system 100, in accordance with one or more embodiments of the present disclosure.

For example, as shown in FIGS. 3A and 3B, multiple hydraulic piston systems 100 may be spaced along the battery stacks 202 to apply pressure to the battery stacks 202. The number and spacing of the hydraulic piston systems 100 may be selected to ensure uniform pressure distribution across the entire surface area of the battery stacks 202 (e.g., even pressure distribution on the battery stacks 202 by the head 106 of the pistons 102).

The use of multiple hydraulic piston systems 100 may also provide redundancy and fault tolerance, allowing the solid-state battery module 200 to maintain pressure even if one or more hydraulic piston systems 100 become inoperative.

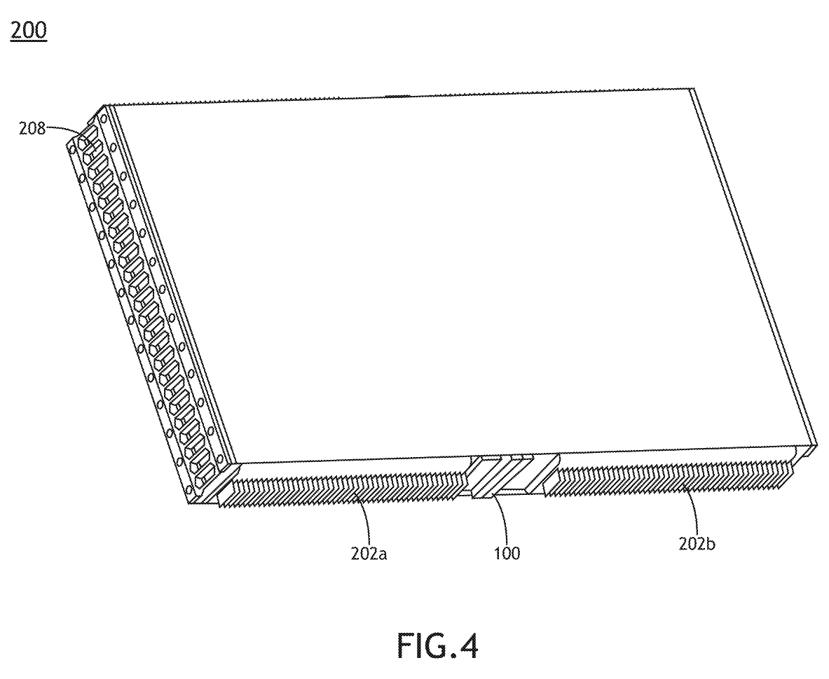

FIG. 4 depicts a perspective view of the solid-state battery module 200, in accordance with one or more embodiments of the present disclosure.

The solid-state battery module 200 may be configured as a standalone unit or as part of a larger battery pack assembly. Additionally, the solid-state battery module 200 may include any components common in solid-state batteries. For example, the solid-state battery module 200 may include electrical interconnects, thermal management components, and structural features for integration into a vehicle or stationary energy storage system.

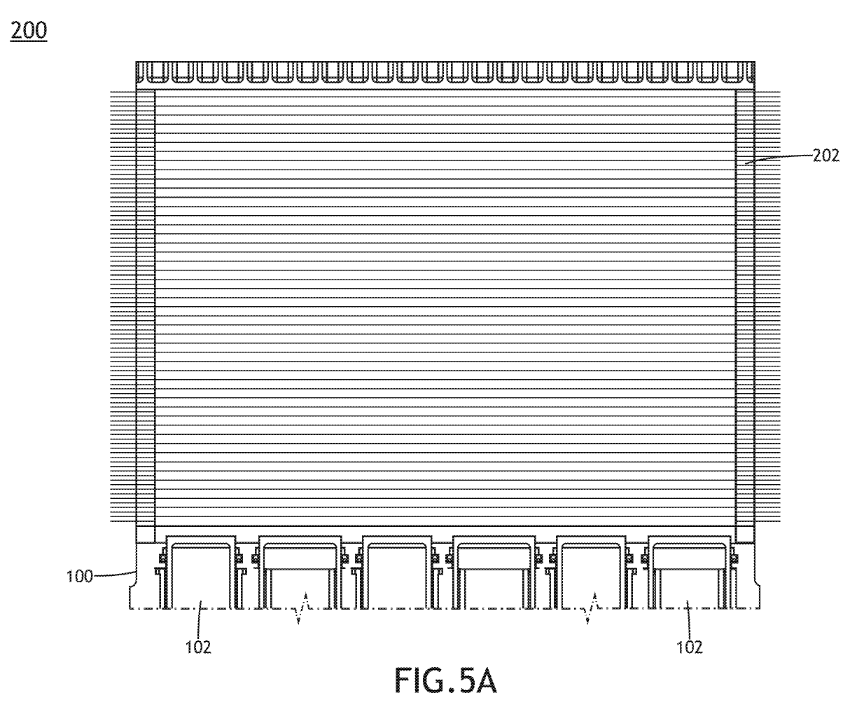

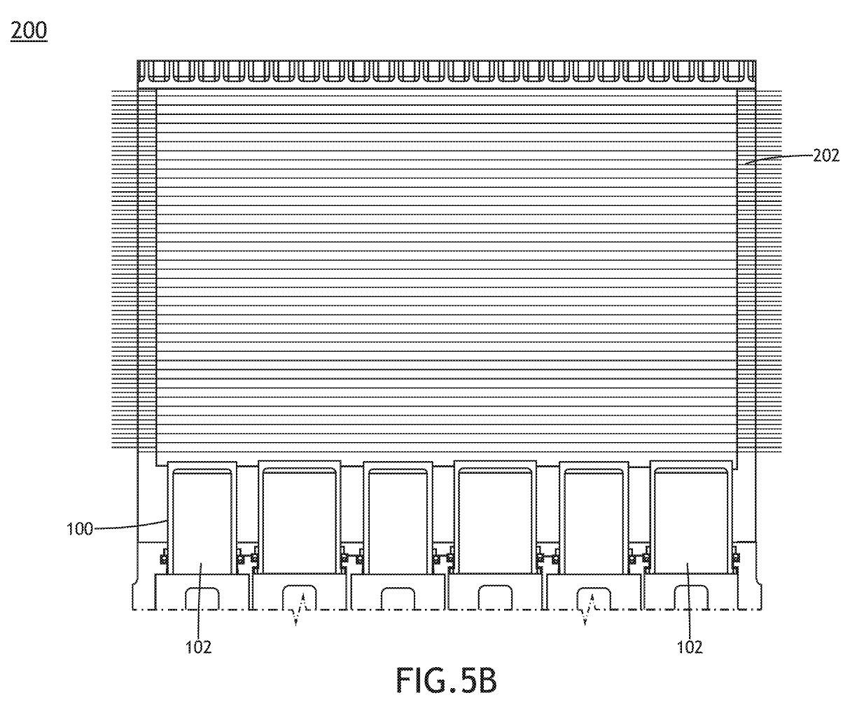

FIG. 5A depicts a cross-sectional view of a solid-state battery module 200 with an unextended hydraulic piston system 100 including a single piston 102, in accordance with one or more embodiments of the present disclosure. FIG. 5B depicts a cross-sectional view of the solid-state battery module 200 with an extended hydraulic piston system 100 including the single piston 102, in accordance with one or more embodiments of the present disclosure.

In embodiments, the one or more battery stacks 202 include a single battery stack 202. This configuration may be used in smaller modules or in applications where bilateral compression of multiple battery stacks 202 is not required.

In embodiments, the one or more pistons 102 include a single piston 102. The single piston 102 may be configured to apply pressure to the single battery stack 202 from one side, with the opposite side supported by a fixed end plate 208 or another structural member.

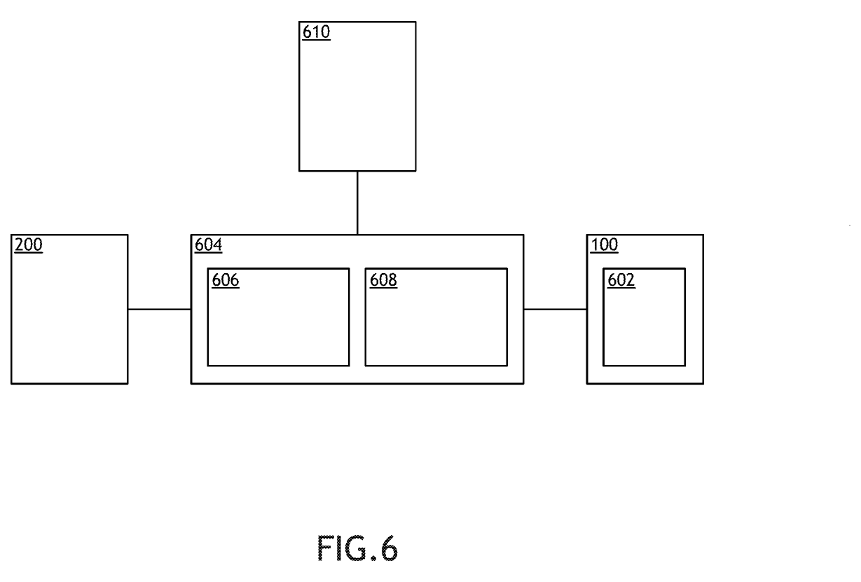

FIG. 6 depicts a block diagram of the hydraulic piston system 100, in accordance with one or more embodiments of the present disclosure.

In embodiments, the hydraulic piston system 100 includes a hydraulic subsystem 602. The hydraulic subsystem 602 may include a pump (e.g., an electrically driven pump), an accumulator to buffer pressure fluctuations, and a network of valves (e.g., check valves, pressure relief valves, and proportional control valves) to regulate fluid flow. The hydraulic subsystem 602 may be configured to maintain a target pressure within the hydraulic piston system 100 and to compensate for fluid losses, thermal expansion, or changes in height of the battery stacks 202.

In embodiments, the hydraulic piston system 100 includes a controller 604 communicatively coupled to the hydraulic piston system 100 and/or the battery stacks 202, the controller 604 including one or more processors 606 programmed to execute a set of program instructions stored in memory 608. The controller 604 may further be coupled to one or more sensors 610. The sensors 610 may be designed to monitor the solid-state battery module 200 and provide data to the controller 604 for processing.

In embodiments, when executed, the set of program instructions causes the processors to cause the pistons 102 to actuate to apply the pressure to the battery stacks 202. The controller may monitor readings from the sensors 610, such as pressure, and temperature, and charge state, and may adjust the hydraulic pressure applied by the hydraulic piston system 100 accordingly.

In embodiments, when executed, the set of program instructions causes the processors to monitor the charge state of the battery stacks 202 and cause the pistons 102 to apply different pressures to the battery stacks 202 as the charge state of the battery stacks 202 changes. For example, the hydraulic piston system 100 may increase pressure at high or low states of charge to improve performance. Additionally, the hydraulic piston system 100 may reduce pressure during idle periods to minimize mechanical stress. The controller 604 may also implement safety protocols, such as overpressure protection, leak detection, and fault isolation.

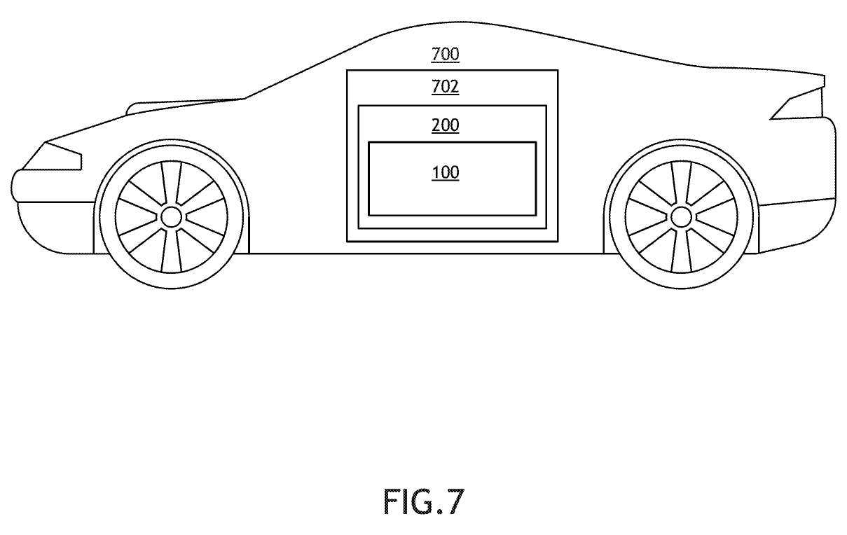

FIG. 7 depicts a block diagram of an electric vehicle 700 including the solid-state battery module 200 incorporating the hydraulic piston system 100, in accordance with one or more embodiments of the present disclosure.

The electric vehicle 700 may include one or more solid-state battery modules 200 as described herein. The solid-state battery modules 200 may be used to power the electric drivetrain 702 and auxiliary systems of the electric vehicle 700. For example, the electric drivetrain 702 may include an electric motor designed to receive power from the solid-state battery modules to power the wheels of the electric vehicle 700.

The integration of the hydraulic piston system 100 may enable improved energy density, thermal stability, and cycle life of the battery cells, while also supporting fast charging and high-power operation. The hydraulic piston system 100 may be particularly advantageous in applications requiring compact packaging, high reliability, and precise control of mechanical loading on battery cells.

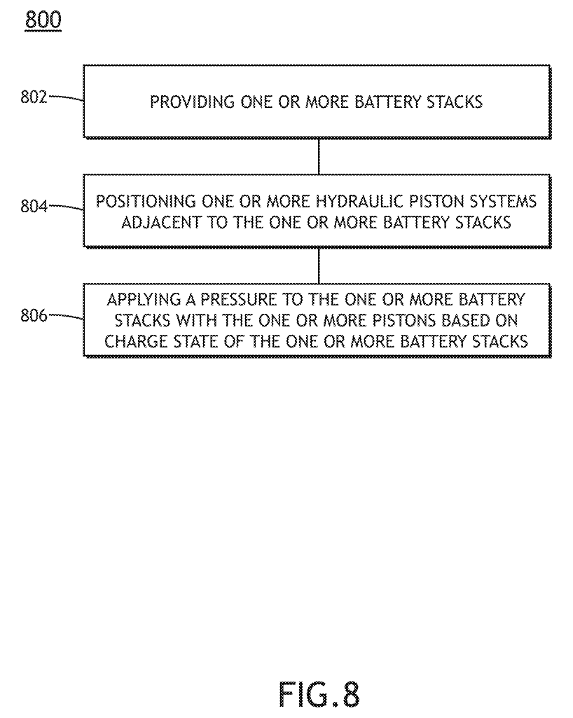

FIG. 8 depicts a flow diagram of a method 800 for compression of battery stacks in solid-state battery modules, in accordance with one or more embodiments of the present disclosure.

In embodiments, the method 800 includes a step 802 of providing one or more battery stacks. Each battery stack may include solid-state battery cells stacked upon each other. Additionally, each of the solid-state battery cells may be separated by materials, such as compliant materials, heating mats, or cooling loops disposed to support pressure uniformity and thermal management.

In embodiments, the method 800 includes a step 804 of positioning one or more hydraulic piston systems adjacent to the one or more battery stacks. The hydraulic piston systems may include one or more pistons housed within a central housing. The hydraulic piston systems may be positioned to apply pressure to battery stacks from one or both sides. In some embodiments, the pistons may be nested to reduce the overall length of the module and accommodate cell expansion during operation.

In embodiments, the method 800 includes a step 806 of applying a pressure to the one or more battery stacks with the one or more pistons based on charge state of the one or more battery stacks. The pressure may be applied by actuating the pistons hydraulically. For example, the hydraulic subsystem may include a pump, accumulator, and control valves. The pressure to the battery stacks may be maintained at a substantially constant level (e.g., between 0 and 5 MPa) to accommodate battery cell swelling and contraction during charge and discharge cycles. In some embodiments, the pressure may be dynamically adjusted by a controller based on the state of charge, temperature, or current demand of the battery stacks, thereby optimizing performance and mitigating degradation.

Referring again to the controller 604, additional aspects of the controller 604, the processors 606, and the memory 608 are described. In some embodiments, the controller 604 includes one or more processors 606. For example, the one or more processors 606 may be designed to execute a set of program instructions maintained in the memory 608, or a memory device.

The one or more processors 606 of a controller 604 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors 606 may include any device designed to execute algorithms and/or instructions (e.g., program instructions stored in memory). Moreover, different subsystems of the hydraulic piston system 100 and/or the solid-state battery module 200 may include a processor or logic elements suitable for carrying out at least a portion of the steps described in the present disclosure. Further, the steps described throughout the present disclosure may be carried out by a single controller or, alternatively, multiple controllers.

The memory 608 may include any storage medium known in the art suitable for storing program instructions executable by the associated one or more processors 606. For example, the memory 608 may include volatile and non-volatile memory medium. For instance, the memory 608 may include RAM, SRAM, DRAM, ROM, PROM, EEPROM, flash memory, or the like.

One skilled in the art will recognize that the herein described components, operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments.

With respect to the use of substantially any plural and/or singular terms herein, those having skill in the art can translate from the plural to the singular and/or from the singular to the plural as is appropriate to the context and/or application. The various singular/plural permutations are not expressly set forth herein for the sake of clarity.

While embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 hydraulic piston system
102 piston
102a first piston
102bsecond piston
104 body
106 head
108 lip
110 housing
112 opening
114 restriction
lip 200 solid-state battery module
202 battery stack
202a first battery stack
202bsecond battery stack
204 battery cell
206 material
208 end plate
602 hydraulic subsystem
604 controller
606 processor
608 memory
610 sensor
700 electric vehicle
702 electric drivetrain
800 method
802 step
804 step
806 step

What is claimed:

1. A solid-state battery module comprising:
one or more battery stacks, each of the one or more battery stacks comprising a plurality of battery cells stacked upon each other; and
one or more hydraulic piston systems, each of the one or more hydraulic piston systems comprising:
one or more pistons configured to apply a pressure to the one or more battery stacks based on charge state of the one or more battery stacks, wherein each of the one or more pistons comprises: a body; and a head at an end of the body, wherein the head is in contact with the one or more battery stacks; and
a housing surrounding the one or more pistons, wherein the one or more pistons extend from the housing to apply the pressure on the one or more battery stacks.

2. The solid-state battery module of claim 1, wherein the one or more battery stacks comprise:
a first battery stack; and
a second battery stack.

3. The solid-state battery module of claim 2, wherein the one or more hydraulic piston systems are disposed between the first battery stack and the second battery stack.

4. The solid-state battery module of claim 3, wherein the one or more pistons comprise:
a first piston; and
a second piston, wherein the housing surrounds both the first piston and the second piston, wherein the first piston and the second piston extend from opposite sides of the housing such that the first piston applies the pressure to the first battery stack and the second piston applies the pressure to the second battery stack.

5. The solid-state battery module of claim 4, wherein when the first piston and the second piston are unextended, the second piston is designed to nest inside the first piston.

6. The solid-state battery module of claim 1, wherein the one or more battery stacks comprise:
a single battery stack.

7. The solid-state battery module of claim 6, wherein the one or more pistons comprises:
a single piston to apply pressure to the single battery stack.

8. The solid-state battery module of claim 1, wherein each of the one or more pistons further comprises:
a lip at an opposite end of the body from the head.

9. The solid-state battery module of claim 8, wherein the housing further comprises:
one or more restriction lips corresponding to the one or more pistons, wherein the one or more restriction lips are designed to restrict motion of the one or more pistons by physical interaction with the lip of each of the one or more pistons.

10. The solid-state battery module of claim 1, wherein each of the one or more battery stacks further comprises:
an end plate.

11. The solid-state battery module of claim 10, wherein the end plate of each of the one or more battery stacks is designed to absorb the pressure applied by the one or more pistons.

12. The solid-state battery module of claim 10, wherein the end plate of each of the one or more battery stacks is designed to provide a mounting point for the one or more battery stacks.

13. The solid-state battery module of claim 1, wherein a material is disposed between each of the plurality of battery cells of the one or more battery stacks.

14. The solid-state battery module of claim 13, wherein the material disposed between each of the plurality of battery cells of the one or more battery stacks is at least one of a compliant material, a heating mat, or a cooling loop.

15. The solid-state battery module of claim 1, wherein the pressure applied to the one or more battery stacks based on the charge state of the one or more battery stacks is designed to be a constant pressure based on expansion and contraction of the plurality of battery cells of the one or more battery stacks.

16. The solid-state battery module of claim 1, wherein the head of each of the one or more pistons is designed such that the one or more pistons apply the pressure to an entire surface of the one or more battery stacks.

17. The solid-state battery module of claim 1, further comprising:
a controller communicatively coupled to the one or more hydraulic piston systems, the controller including one or more processors programmed to execute a set of program instructions stored in memory, which when executed, causes the one or more processors to cause the one or more pistons to actuate to apply the pressure to the one or more battery stacks.

18. The solid-state battery module of claim 17, wherein the controller is further configured to:
monitor the charge state of the one or more battery stacks and cause the one or more pistons to apply different pressures to the one or more battery stacks as the charge state of the one or more battery stacks changes.

19. An electric vehicle comprising:
an electric drivetrain; and
a solid-state battery module to power the electric drivetrain, the solid-state battery module comprising:
one or more battery stacks, each of the one or more battery stacks comprising a plurality of battery cells stacked upon each other; and
one or more hydraulic piston systems, each of the one or more hydraulic piston systems comprising:
one or more pistons configured to apply a pressure to the one or more battery stacks based on charge state of the one or more battery stacks, wherein each of the one or more pistons comprises: a body; and a head at an end of the body, wherein the head is in contact with the one or more battery stacks; and
a housing surrounding the one or more pistons, wherein the one or more pistons extend from the housing to apply the pressure on the one or more battery stacks.

20. A method comprising:
providing one or more battery stacks, each of the one or more battery stacks comprising a plurality of battery cells stacked upon each other;
positioning one or more hydraulic piston systems adjacent to the one or more battery stacks, each of the one or more hydraulic piston systems comprising: one or more pistons and a housing surrounding the one or more pistons, wherein each of the one or more pistons comprises: a body; and a head at an end of the body, wherein the head is in contact with the one or more battery stacks, wherein the one or more pistons extend from the housing; and
applying a pressure to the one or more battery stacks with the one or more pistons based on charge state of the one or more battery stacks.
